(19) United States
(12) Patent Application Publication
(10) Pub. No.: US 2025/0211521 A1
(43) Pub. Date: Jun. 26, 2025

(54) TRANSMISSIONS OF DATA PACKETS IN A MESH COMMUNICATION NETWORK OF THE LOCAL AREA NETWORK TYPE

(71) Applicant: SAGEMCOM BROADBAND SAS, Bois-Colombes (FR)

(72) Inventors: Antonie ROCQUELAY, Bois-Colombes (FR); Laurent ALARCON, Bois-Colombes (FR); Sylvain LE ROUX, Bois-Colombes (FR)

(73) Assignee: SAGEMCOM BROADBAND SAS, Bois-Colombes (FR)

(21) Appl. No.: 19/000,640

(22) Filed: Dec. 23, 2024

(30) Foreign Application Priority Data
Dec. 22, 2023 (FR) 2315018

(51) Int. Cl. H04L 45/48

(52) U.S. Cl. CPC H04L 45/48

(57) ABSTRACT

A method of transmitting data packets in a mesh communication network of the local area network type that interconnects bridge devices, each bridge device uses in parallel: a first configuration of a first logic network, which is used for conveying data packets in unicast mode and which is defined by a dynamic routing between the bridge devices; and a second configuration of a second logic network, which is used for conveying data packets in broadcast or multicast mode and which is defined as a spanning tree by blocking one or more ports of the bridge devices to eliminate one or more loops in the mesh communication network.

### TECHNICAL FIELD

The present invention relates to transmissions of data packets in a mesh communication network of the local area network type wherein bridge devices are interconnected.

### PRIOR ART

Several solutions exist for implementing a mesh communication network of the local area network type, for example for interconnecting wireless (e.g. Wi-Fi) network extenders to a residential gateway, and in particular bridge-device technologies.

However, in the context of these solutions, a spanning tree is defined so as to connect all the bridge devices while eliminating any loop in the mesh communication network. Loops in the mesh communication network then introduce redundancies that are used as a backup path if a main path of the spanning tree were to yield. The spanning tree is then redefined in order to use such backup paths rather than faulty main paths that were previously used. Nevertheless, at a given instant, only the main paths are used for all the communications in the mesh communication network, then preventing implementing a specific routing of the data packets. Such a topology makes it possible in fact to optimise only communications from, and to, the root of said spanning tree.

It is desirable to overcome these drawbacks of the prior art. It is in particular desirable to provide a solution that makes it possible to improve the routing of data packets in such mesh communication networks, in order better to benefit from the redundancy offered by the meshing of these mesh communication networks rather than relying on a spanning tree for conveying these data packets.

### DISCLOSURE OF THE INVENTION

A method is proposed here for transmitting data packets in a mesh communication network of the local area network type that interconnects bridge devices, wherein each bridge device uses in parallel:
a first configuration of a first logic network, which is used for conveying data packets in unicast mode, and which is defined by a dynamic routing between the bridge devices; and
a second configuration of a second logic network, which is used for conveying data packets in broadcast or multicast mode, and which is defined as a spanning tree by blocking one or more ports of the bridge devices to eliminate one or more loops in the mesh communication network.

Thus, by virtue of this parallel use of the first configuration of a first logic network to convey data packets in unicast mode and of the second configuration of a second logic network for conveying data packets in broadcast or multicast mode, redundancies offered by the meshing of the mesh communication network are used to optimise data transmissions in unicast mode.

According to a particular embodiment, the second configuration of a second logic network is obtained by using a virtual local network.

According to a particular embodiment, in each bridge device, the first configuration of a first logic network involves a retranscription of a list at layer 3 of the OSI model in an OSI-model layer-2 forwarding database, the list listing the OSI-model layer-3 address of each device in the mesh communication network or connected to the mesh communication network in association with a port identifier of the bridge device in question to be used for conveying data packets intended for the device in question, the list being obtained during the dynamic routing.

According to a particular embodiment, when a new station device is connected to a port of a said bridge device, each bridge device performs the following steps:
using the second configuration of the second logic network for conveying, in the mesh communication network, a discovery request coming from the new station device;
updating the OSI-model layer-2 forwarding database of the bridge device in question with a MAC address of the new station device in association with an identifier of the port, of the device in question, via which the discovery request arrived;
using the OSI-model layer-2 forwarding database thus updated to convey, in the mesh communication network, a response to the discovery request, in which an OSI-model layer-3 address, which is allocated to the new base station, is included;
enriching the list at layer 3 of the OSI model with the OSI-model layer-3 address, which is allocated to the new base station, and determining the port identifier to be associated therewith by means of the dynamic routing;
modifying the OSI-model layer-2 forwarding database of the bridge device in question to retranscribe, where applicable, the dynamic routing corresponding to the OSI-model layer-3 address allocated to the new station device.

According to a particular embodiment, the first configuration of the first logic network is obtained by OSI-model layer-3 message exchanges between immediate neighbours of the mesh communication network among the bridge devices.

According to a particular embodiment, the first configuration of a first logic network and the second configuration of a second logic network are updated in the event of change of topology of the mesh communication network that interconnects the bridge devices, and the first configuration of a first logic network only is updated in the event of connection of a station device to the mesh communication network or of disconnection of the station device from the mesh communication network.

A computer program product is also proposed here, comprising instructions causing an implementation of the method disclosed above in any one of its embodiments, when the instructions are executed by a processor. An information storage medium is also proposed, comprising instructions causing an implementation of the method disclosed above in any one of its embodiments, when the instructions are read from the information storage medium and executed by a processor.

A bridge device is also proposed here, intended to be used in a mesh communication network of the local area network type that interconnects several such bridge devices, the bridge device comprising electronic circuitry configured to use in parallel:
a first configuration of a first logic network, which is used for conveying data packets in unicast mode, and which is defined by a dynamic routing between the bridge devices; and
a second configuration of a second logic network, which is used for conveying data packets in broadcast or multicast mode, and which is defined as a spanning tree by blocking one or more ports of the bridge devices to eliminate one or more loops in the mesh communication network.

A mesh communication network of the local area network type is also proposed here, which interconnects several bridge devices as disclosed above.

According to a particular embodiment, one said bridge device is included in a residential gateway and the other said bridge devices are respectively included in extenders of a local area network.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically a mesh communication network;

FIG. 2 illustrates schematically an example of hardware arrangement adapted to implement a device of the mesh communication network;

FIG. 3A illustrates schematically an algorithm of a method for transmitting data packets in the mesh communication network;

FIG. 3B illustrates schematically an algorithm of a method for taking into account a new station device connected to the mesh communication network;

FIG. 4 illustrates schematically the mesh communication network according to an example of configuration of a logic network adapted to transmissions of data packets in broadcast or multicast mode;

FIG. 5A illustrates schematically operations of conveying a discovery request in the mesh communication network;

FIG. 5B illustrates schematically forwarding database contents, at layer 2 of the OSI model, of bridge devices of the mesh communication network following the discovery-request conveying operations of FIG. 5A;

FIG. 5C illustrates schematically operations of conveying, in the mesh communication network, a response to the discovery request of FIG. 5A;

FIG. 5D illustrates schematically exchanges between bridge devices that are immediate neighbours in the mesh communication network;

FIG. 5E illustrates schematically contents of lists, at layer 3 of the OSI model, following the exchanges of FIG. 5D; and

FIG. 5F illustrates schematically a retranscription, in the forwarding databases of the bridge devices, of the contents of the lists of FIG. 5E.

### DETAILED DISCLOSURE OF EMBODIMENTS

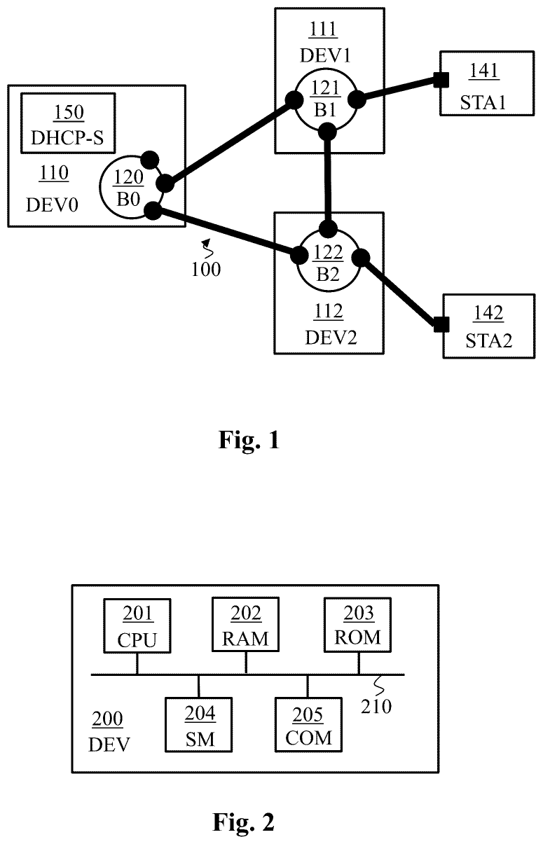

FIG. 1 thus illustrates schematically a mesh communication network 100 of the local area network type that interconnects bridge devices B0 120, B1 121, B2 122.

The bridge devices B0 120, B1 121, B2 122 conjointly establish routing mechanisms for conveying data packets in the mesh communication network 100. The mesh communication network 100 is adapted and configured to accommodate station devices STA1 141, STA2 142 and to enable them to communicate through the mesh communication network 100. For example, the station devices STA1 141, STA2 142 can communicate with each other and/or communicate with a functionality of a device in which a so-called bridge device is included, such as a gateway functionality (e.g. for accessing the internet) or a DHCP (“Dynamic Host Configuration Protocol”) server functionality.

The station devices STA1 141, STA2 142 are for example computers, electronic tablets or multifunction mobile telephones, or any type of communicating electronic equipment (TV, audiovisual set-top box, etc). End device is also spoken of in an equivalent manner.

The bridge devices are typically included in devices offering additional functionalities. Thus, on FIG. 1, the bridge device B0 120 is included in a device DEV0 110, the bridge device B1 121 is included in a device DEV1 111 and the bridge device B2 122 is included in a device DEV2 112. Thus, for example, the device DEV0 110 that includes the bridge device B0 120 furthermore includes a DHCP server (labelled DHCP-S on FIG. 1) 150.

In one embodiment, a bridge device (the bridge device B0 120 on FIG. 1) is included in a residential gateway, and the other bridge devices (the bridge devices B1 121 and B2 122 on FIG. 1) are respectively included in extenders of a wireless local area network, such as Wi-Fi extenders that make it possible to extend the Wi-Fi coverage of a local area network.

More precisely, to convey the data packets in the mesh communication network 100, each of the bridge devices B0 120, B1 121, B2 122 uses in parallel:
a first configuration of a first logic network, which is used for conveying data packets in unicast mode, and which is defined by a dynamic routing (also called adaptive routing) between the bridge devices B0 120, B1 121, B2 122; and
a second configuration of a second logic network, which is used for conveying data packets in broadcast or multicast mode, and which is defined as a spanning tree by blocking one or more ports of the bridge devices B0 120, B1 121, B2 122 to eliminate one or more loops in the mesh communication network 100.

In one a particular embodiment, the second configuration of a second logic network is obtained by using a virtual local network. In other words, a virtual local network is used for performing various operations for defining the spanning tree. This makes it possible to easily ensure that these operations do not interfere with the definition of the first configuration of a first logic network.

For reasons of simplicity of description, FIG. 1 presents a mesh communication network comprising only three bridge devices. It is however understood that what is described here applies to mesh communication networks having much more complex meshings with a larger number of bridge devices.

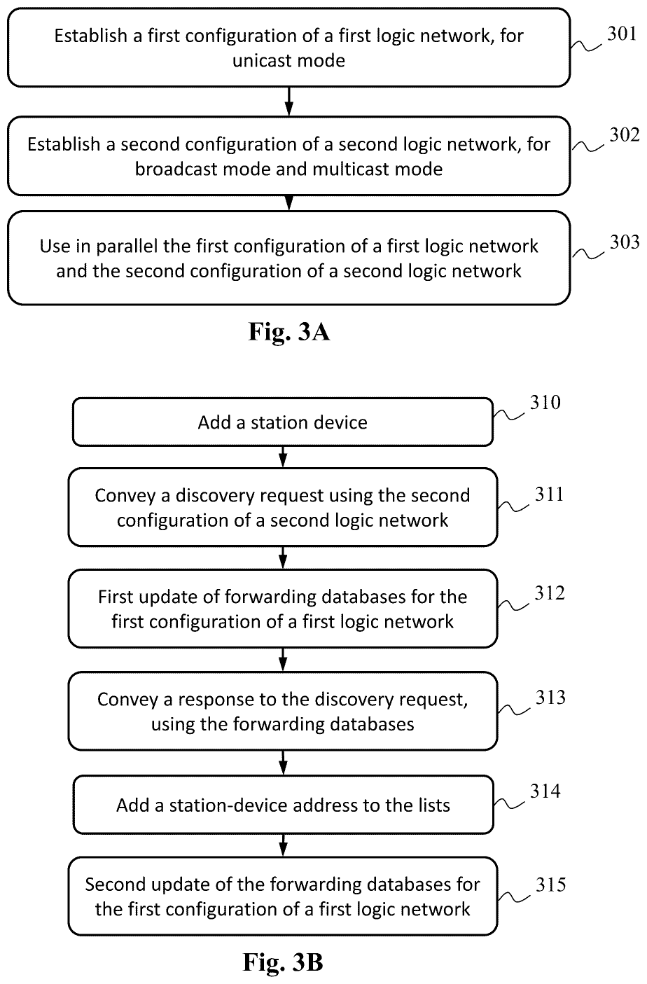

FIG. 2 illustrates schematically an example of hardware arrangement adapted to implement a device DEV 200 of the mesh communication network 100, such as the devices DEV0 110, DEV1 111 and DEV2 112.

The hardware arrangement presented comprises, connected by a communication bus 210: a processor or CPU (“central processing unit”) 201; a random access memory (RAM) 202; a non-volatile memory, for example of the ROM (read only memory) 203 or EEPROM (“electrically-erasable programmable read-only memory”) type, or of the flash type; a storage unit, such as a storage medium SM 204, for example a hard disk drive HDD, or a storage medium reader, such as an SD (Secure Digital) card reader; and a communication interface manager COM 205.

The communication interface manager COM 205 enables the hardware arrangement presented to interact with other devices of the mesh communication network 100 or which are connected to the mesh communication network 100. The communication interfaces are for example Wi-Fi interfaces on various frequency bands (2.4 GHz, 5 GHz, 6 GHz), Ethernet interfaces, etc. It should be noted that several bridge-device ports can be virtualised on one and the same physical communication interface.

The processor or CPU 201 is capable of executing instructions loaded in the random access memory 202, in particular from the non-volatile memory 203 or from the storage medium SM (such as an SD card) 204. When the hardware arrangement presented is powered up, the processor or CPU 201 is thus capable of reading instructions from the random access memory RAM 202 and executing them. These instructions form a computer program causing in particular the implementation, by the processor or CPU 201, of the steps, methods and behaviours described here in relation to the device to which the device DEV 200 corresponds.

All or some of the steps, methods and behaviours described here can thus be implemented in software form by executing a set of instructions by a programmable machine, for example a processor of the DSP (“digital signal processor”) type, or a microcontroller, or be implemented in hardware form by a machine or a dedicated electronic component (chip) or a dedicated set of electronic components (chipset), for example an FPGA (field-programmable gate array) or ASIC (application-specific integrated circuit) component. In general terms, the devices of the mesh communication network 100, such as the devices DEV0 110, DEV1 111 and DEV2 112 (and consequently the bridge devices B0 120, B1 121, B2 122) comprise electronic circuitry adapted and configured to implement the steps, methods and behaviours described here.

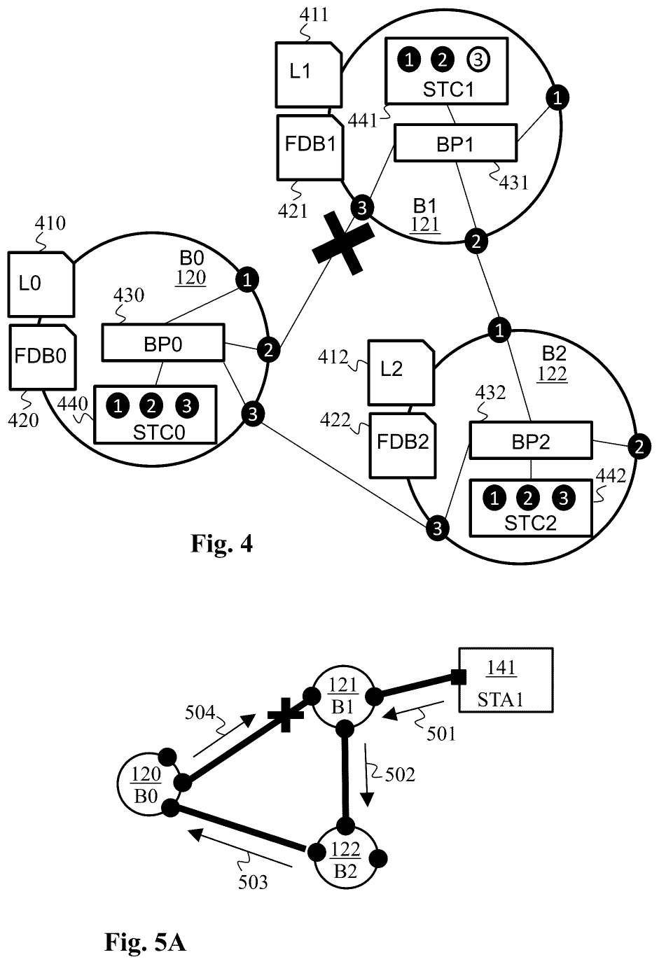

FIG. 3A illustrates schematically an algorithm of a method for transmitting data packets in the mesh communication network 100.

In a step 301, the bridge devices B0 120, B1 121, B2 122 cooperate to establish a first configuration of a first logic network that is intended to convey data packets in unicast mode through the mesh communication network 100. More particularly, each bridge device B0 120, B1 121, B2 122 establishes the first configuration of a first logic network, which is defined by a dynamic routing between the bridge devices.

Dynamic routing is a process, well known to persons skilled in the art of mesh communication networks, during which the bridge devices B0 120, B1 121, B2 122 establish paths to be taken by the data packets in unicast mode from various candidate paths between a source device and a destination device in the mesh communication network 100, according to transmission costs determined for the various candidate paths. For example, the bridge devices B0 120, B1 121, B2 122 use a dynamic-routing protocol such as a distance-vector routing protocol, or a link-state routing protocol, or the OSPF (“Open Shortest Path First”) protocol as defined in its 2nd version in the normative document RFC 2328.

Thus the first configuration of a first logic network makes it possible to take advantage of the meshing (and therefore of potential loops) offered by the mesh communication network 100 for optimising the paths taken by the data-packet transmissions in unicast mode.

In a step 302, the bridge devices B0 120, B1 121, B2 122 cooperate to establish a second configuration of a second logic network that is intended to convey data packets in broadcast mode and data packets in multicast mode through the mesh communication network 100. More particularly, each bridge device B0 120, B1 121, B2 122 establishes the second configuration of a second logic network, which is defined as a spanning tree by blocking one or more ports of the bridge devices to eliminate one or more loops in the mesh communication network 100.

A spanning tree, well known to persons skilled in the art of mesh communication networks, is a subset of interconnections of a mesh communication network interconnecting node devices that covers all the node devices without redundancy of connection between the node devices. The spanning tree is typically obtained according to a layer-2 protocol (link layer) in the OSI (“Open Systems Interconnection”) model. For example, the bridge devices B0 120, B1 121, B2 122 use the STP protocol (“Spanning Tree protocol”) as defined in IEEE 802.1D. The root of the spanning tree may be a bridge device in particular, such as for example a bridge device included in a residential gateway.

The steps 301 and 302 can be performed in reverse order. The steps 301 and 302 are reiterated when a change of topology occurs in the mesh communication network 100 (insertion of a bridge device, disappearance of a bridge device, appearance of a new link between bridge devices, disappearance of a link between bridge devices, change of at least one characteristic of at least one link between bridge devices so as to cause a change in at least one route score (or cost) in the mesh communication network 100, and therefore a determination of optimised new routes through the mesh communication network 100 and optionally of a new spanning tree).

In a step 303, each bridge device B0 120, B1 121, B2 122 uses in parallel the first configuration of a first logic network to convey data packets in unicast mode through the mesh communication network 100, and the second configuration of a second logic network to convey data packets in broadcast or multicast mode in the mesh communication network 100.

When a modification of topology of the mesh communication network 100 in the interconnections between the bridge devices occurs, the step 301 and the step 302 are repeated to optionally modify the first configuration of a first logic network (new optimisation of the unicast paths) and the second configuration of a second logic network (new spanning-tree definition). For example, one of the devices DEV0 110 or DEV1 111 or DEV2 112 already present in the mesh communication network 100 has its characteristics changed or modified to the point of causing a change in topology of the mesh communication network 100. It may be a case for example of adding a connectivity module providing an additional port. It may also be a case of a fault affecting one of the ports. It may also be a case for example of a software update modifying wireless communication functionalities or modifying the configuration of the device in question.

FIG. 3B illustrates schematically an algorithm of a method for taking into account a new station device connected to the mesh communication network 100. The new station device designates a device or item of equipment newly arrived or connected to the mesh communication network 100.

In a step 310, a new station device is connected to the mesh communication network 100. The new station device is connected through a port of a bridge device of the mesh communication network 100.

In a step 311, a discovery request is transmitted by the new station device in order to obtain a routable address, namely a layer-3 address of the OSI model. The discovery request is transmitted in broadcast mode, so that conveying the discovery request follows the second configuration of a second logic network (spanning tree).

In a step 312, as the broadcast of the discovery request progresses in the mesh communication network, an OSI-model layer-2 forwarding database of each bridge device is updated with an OSI-model layer-2 address (typically a MAC (“Medium Access Control”) address) of the new base station in association with an identifier of the port, of the bridge device in question, by means of which the discovery request arrived.

In a step 313, a response to the discovery request is transmitted to the new station device. A routable address, of layer 3 in the OSI model, which is allocated to the new base station, is included in the response to the discovery request. The response to the discovery request is transmitted in unicast mode. Thus, in each bridge device on the path, the OSI-model layer-2 forwarding database as updated at the step 312 is used.

In a step 314, the routable address, of layer 3 in the OSI model, attributed to the new station device, is added to a list L that lists OSI-model layer-3 addresses of the device present in the mesh communication network 100 or connected to the mesh communication network 100, and this in each bridge device of the mesh communication network 100. In each list L, each OSI-model layer-3 address is associated with the identifier of the port (of the bridge device in question) by which to communicate in unicast mode with the device to which the address in question is allocated, this port being determined by the dynamic routing. The address of the new base station thus enriches the list L in each bridge device.

It should be noted that, in each bridge device, the list L may have a format similar to a routing table; however, this list L is not used to implement routing, and it is a retranscription of this list L at layer 2 of the OSI model that will enable the bridge device in question to convey the data packets in an optimised manner in unicast mode in the mesh communication network 100.

In a step 315, the dynamic routing corresponding to the OSI-model layer-3 address allocated to the new station device is retranscribed, for each bridge device of the mesh communication network 100, in the OSI-model layer-2 forwarding database of the bridge device in question. In each bridge device, the list L mentioned at the step 314 is used to do this. A second update of the OSI-model layer-2 forwarding database of each bridge device is implemented where applicable to take into account the dynamic routing corresponding to the new station device.

The method of FIG. 3A is described above in relation to the addition of a station device. The same behaviour applies in the context of an addition of a new bridge device (the OSI-model layer-3 address of which therefore appears in the list L of the other bridge devices of the mesh communication network 100, which gives rise to a retranscription in their OSI-model layer-2 forwarding database). It may be a case for example of a wireless communication coverage extension device (“extender”) newly added in the topology of the mesh communication network 100.

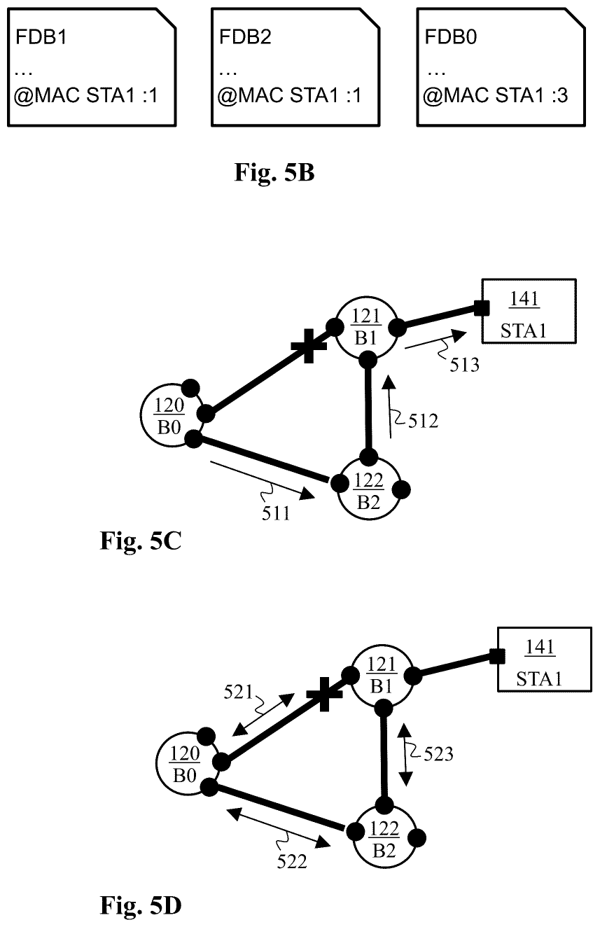

An example of implementation of the methods of FIGS. 3A and 3B is detailed hereinafter. FIG. 4 illustrates schematically the mesh communication network 100 of FIG. 1 according to an example of a second configuration of a second logic network (i.e. to convey data packets in broadcast or multicast mode).

As illustrated on FIG. 1, the mesh communication network 100 has a loop between the bridge devices B0 120, B1 121, B2 122, which each have three ports, numbered 1 to 3. As detailed on FIG. 4, the port 2 of the bridge device B0 120 is connected to the port 3 of the bridge device B1 121, the port 3 of the bridge device B0 120 is connected to the port 3 of the bridge device B2 122, and the port 1 of the bridge device B0 120 is not connected to any bridge device. In addition, the port 2 of the bridge device B1 121 is connected to the port 1 of the bridge device B2 122, and the port 1 of the bridge device B1 121 and the port 2 of the bridge device B2 122 are not connected to any bridge device.

Each bridge device comprises a bridge processor (hardware or software) connected to each of the ports of the bridge device in question, in order to process data packets that pass via these ports. Thus the bridge device B0 120 comprises a bridge processor BP0 430, the bridge device B1 121 comprises a bridge processor BP1 431, and the bridge device B2 122 comprises a bridge processor BP2 432.

Each bridge device furthermore comprises a forwarding database of layer 2 of the OSI model. The forwarding database comprises inputs indicating addresses, of layer 2 of the OSI model, of known devices of the communication network 100, in association with the identifier of the port of the bridge device in question via which any data packet intended for the known device in question must leave.

Each bridge device furthermore comprises a list L as already mentioned above (of layer 3 of the OSI model). Thus the bridge device B0 120 comprises a list L0 410, the bridge device B1 121 comprises a list L1 411, and the bridge device B2 122 comprises a list L2 412.

For the unicast mode, if for a device the forwarding database were not to be given, the data packet intended for the device in question would be discarded. Such a situation is possible during a transient phase of propagating dynamic routing rules and of retranscription thereof, in each bridge device, in the forwarding database.

Each bridge device furthermore comprises a description of the second configuration of a second logic network as must be locally applied by the bridge device in question. For each bridge device, this description reflects the result of the local definition of the spanning tree to be applied in the mesh communication network 100. Thus the bridge device B0 120 comprises a description STC0 440 of the second configuration of a second logic network that indicates that the three ports of the bridge device B0 120 are kept in the applicable spanning tree. This means that a data packet transmitted in broadcast or multicast mode that is received via any of the ports of the bridge device B0 120 is propagated by the bridge processor BP0 430 via the other ports of the bridge device B0 120. In the same way, the bridge device B2 122 comprises a description STC2 442 of the second configuration of a second logic network that indicates that the three ports of the bridge device B2 122 are kept in the applicable spanning tree. This means that a data packet transmitted in broadcast or multicast mode that is received via any of the ports of the bridge device B2 122 is propagated by the bridge processor BP2 432 via the other ports of the bridge device B2 122. A loop elimination is resolved at the bridge device B1 121. Thus the bridge device B1 121 comprises a description STC1 441 of the second configuration of a second logic network that indicates that the ports 1 and 2 of the bridge device B1 121 are kept in the applicable spanning tree but that a blockage of the port 3 of the bridge device B1 121 is effected in the applicable spanning tree. This means that a data packet transmitted in broadcast or multicast mode that is received via the port 3 of the bridge device B1 121 is discarded by the bridge processor BP1 431. In addition, a data packet transmitted in broadcast or multicast mode that is received via the port 1 (or respectively 2) of the bridge device B1 121 is propagated by the bridge processor BP1 431 via the port 2 (or respectively 1) of the bridge device B1 121, but not by the port 3 of the bridge device B1 121. This blockage of the port 3 of the bridge device B1 121, for the data packets transmitted in broadcast or multicast mode, is marked by a cross on FIG. 4.

Thus, by virtue of the blockage of the port 3 of the bridge device B1 121, the first logic network defined according to the topology of the mesh communication network 100 is a spanning tree that includes all the bridge devices B0 120, B1 121, B2 122 without the presence of a loop. The transmission of data packets in broadcast mode and in multicast mode can thus easily be ensured in the mesh communication network 100.

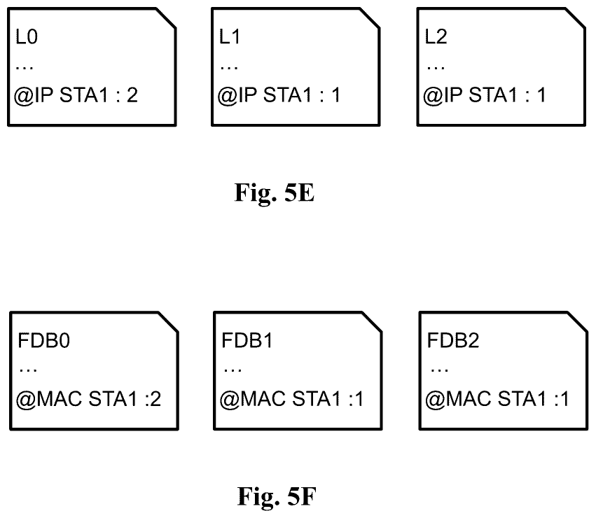

FIG. 5A illustrates schematically operations of conveying a discovery request in the mesh communication network 100 when a new station device is connected to a port of a said bridge device. The new station device added here is, by way of illustration, the station device STA1 141 presented in relation to FIG. 1.

The station device STA1 141 is connected to the port 1 of the bridge device B1 121. The station device STA1 141 seeks to be allocated a routable address, typically of layer 3 in the OSI model (such as an IP (“Internet Protocol”) address) To do this, the station device STA1 141 transmits a discovery request in broadcast mode, in a step 501. In a particular embodiment, the discovery request is a message of the “DHCP Discover” type according to the DHCP protocol.

The conveying in the mesh communication network 100 therefore follows the second logic network detailed above in relation to FIG. 4.

Thus the discovery request is received on the port 1 of the bridge device B1 121, and the bridge processor BP1 431 propagates the discovery request in accordance with the description STC1 441 of the second configuration of a second logic network. The port 3 of the bridge device B1 121 being blocked, the bridge processor BP1 431 propagates the discovery request on the port 2 of the bridge device B1 121, in a step 502. The bridge processor BP1 431 supplies the discovery request also internally to the device DEV1 111 for optional processing (but here the device DEV1 111 is not responsible for responding to the discovery request).

The discovery request is then received on the port 1 of the bridge device B2 122, and the bridge processor BP2 432 propagates the discovery request in accordance with the description STC2 442 of the second configuration of a second logic network. The bridge processor BP2 432 therefore propagates the discovery request on the ports 2 and 3 of the bridge device B2 122, in a step 503. The bridge processor BP2 432 supplies the discovery request also internally to the device DEV2 112 for any processing (but here the device DEV2 112 is not responsible for responding to the discovery request).

The discovery request is then received on the port 3 of the bridge device B0 120, and the bridge processor BP0 430 propagates the discovery request in accordance with the description STC0 440 of the second configuration of a second logic network. The bridge processor BP0 430 therefore propagates the discovery request on the ports 1 and 2 of the bridge device B0 120, in a step 504. The bridge processor BP0 430 supplies the discovery request also internally to the device DEV0 110 for any processing (which is the case here). Since the port 3 of the bridge device B1 121 is blocked, the bridge processor BP1 431 discards the discovery request as propagated by the bridge device B0 120.

As the conveying of the discovery request progresses in the mesh communication network 100, each bridge device updates its own forwarding database with a MAC address of the new station device STA1 141 in association with an identifier of the port, of the bridge device in question, via which the discovery request arrived. Thus, at this stage, the forwarding databases of the bridge devices of the mesh communication network 100 reflect a conveying of data packets to the new station device STA1 141 in unicast mode that follows the second logic network.

FIG. 5B illustrates schematically contents of forwarding databases of bridge devices of the mesh communication network following the discovery-request conveying operations of FIG. 5A.

When the discovery request has been received on the port 1 of the bridge device B1 121, the bridge processor BP1 431 has updated the forwarding database FDB1 421 by adding an entry for the new station device STA1 141. Thus, as illustrated on FIG. 5B, the forwarding database FDB1 421 is updated with the MAC address of the new base station STA1 141, accompanied by the identifier of the port (here the port 1) via which the discovery request sent by the new base station STA1 141 was received by the bridge device B1 121, namely “@MAC STA1: 1”.

And, when the discovery request has been received on the port 1 of the bridge device B2 122, the bridge processor BP2 432 has updated the forwarding database FDB2 422 by adding an entry for the new station device STA1 141. Thus, as illustrated on FIG. 5B, the forwarding database FDB2 422 is updated with the MAC address of the new base station STA1 141, accompanied by the identifier of the port (here the port 1) via which the discovery request sent by the new base station STA1 141 was received by the bridge device B2 122, namely “@MAC STA1: 1”.

Finally, when the discovery request has been received on the port 3 of the bridge device B0 120, the bridge processor BP0 430 has updated the forwarding database FDB0 420 by adding an entry for the new station device STA1 141. Thus, as illustrated on FIG. 5B, the forwarding database FDB0 420 is updated with the MAC address of the new base station STA1 141, accompanied by the identifier of the port (here the port 3) via which the discovery request sent by the new base station STA1 141 was received by the bridge device B0 120, namely “@MAC STA1: 3”.

The discovery request is intended to be processed by a server allocating routable addresses (OSI-model layer-3 addresses). On FIG. 1, the server DHCP-S 150 is able to provide a response to the discovery request sent by the new station device STA1. The server DHCP-S 150 allocates a routable address, of layer 3 in the OSI model (typically an IP address), to the new base station STA1. The server DHCP-S 150 then generates a response to the discovery request, so as to inform the station device STA1 of the routable address that was attributed to it. In a particular embodiment, the response to the discovery request is a message of the “DHCP Offer” type according to the DHCP protocol.

The contents of the forwarding databases FDB0 420, FDB1 421, FDB2 422 make it possible to convey the response to the discovery request, in the mesh communication network 100, in unicast mode although dynamic routing is not yet taken into account for the new station device STA1 141.

FIG. 5C illustrates schematically operations of conveying, in the mesh communication network 100, the response to the discovery request conveyed as schematically illustrated on FIG. 5A.

When the bridge processor BP0 430 receives from the server DHCP-S 150 the response to be transmitted to the new station device STA1 141, the bridge processor BP0 430 scrutinises the forwarding database FDB0 420 to determine via which port to transmit the data packet in unicast mode to the new station device STA1 141. Thus, in a step 511, the bridge processor BP0 430 propagates the response to the discovery request via the port 3 of the bridge device B0 120.

The response to the discovery request is then received on the port 3 of the bridge device B2 122, and the bridge processor BP2 432 scrutinises the forwarding database FDB2 422 to determine via which port to transmit the data packet in unicast mode to the new station device STA1 141. Then, in a step 512, the bridge processor BP2 432 propagates the response to the discovery request via the port 1 of the bridge device B2 122.

The response to the discovery request is then received on the port 2 of the bridge device B1 121, and the bridge processor BP1 431 scrutinises the forwarding database FDB1 421 to determine via which port to transmit a data packet in unicast mode to the new station device STA1 141. Then, in a step 513, the bridge processor BP2 431 propagates the response to the discovery request via the port 1 of the bridge device B1 121. The response to the discovery request is then received by the new station device STA1 141, which then has the routable address (typically the IP address) that was attributed to it.

The content of the forwarding databases FDB0 420, FDB1 421, FDB2 422 is subsequently reviewed during the establishment and the updating of the dynamic routing (configuration of a first logic network). As detailed hereinafter, the establishment and the updating of the dynamic routing is based on exchanges of messages (data packets) gradually between the bridge devices. Consequently, these messages do not need to be propagated as such through the bridge devices B0 120, B1 121, B2 122. The establishment and the updating of the dynamic routing are therefore not impacted by the absence of rules relating to the bridge devices B0 120, B1 121, B2 122 in the forwarding databases FDB0 420, FDB1 421, FDB2 422 at this stage.

FIG. 5D illustrates schematically operations of establishing, or updating, dynamic routing (configuration of a first logic network) in the mesh communication network 100.

Various events modifying network topology give rise to exchanges between immediate neighbours in the mesh communication network 100 among the bridge devices B0 120, B1 121, B2 122: insertion of a bridge device, disappearance of a bridge device, appearance of a new link between bridge devices, disappearance of a link between bridge devices (e.g. degradation of a wireless link below a predefined connection-quality threshold), change of at least one characteristic of at least one link between bridge devices so as to cause a change in at least one route score (or cost) in the mesh communication network 100, and therefore a determination of optimised new routes through the mesh communication network 100.

In a particular embodiment, the bridge devices B0 120, B1 121, B2 122 use, to do this, OSI-model layer-3 addresses that constitute a control addressing plan of the mesh communication network 100. These control addressing plan addresses are dedicated to the communications between immediate neighbours among the bridge devices B0 120, B1 121, B2 122, and the messages that use such addresses are therefore not propagated by the bridge devices B0 120, B1 121, B2 122 in the mesh communication network 100. In this regard, it should be noted that the processing of such messages does not interact with the forwarding databases FDB0 420, FDB1 421, FDB2 422. These communications between immediate neighbours among the bridge devices B0 120, B1 121, B2 122 are represented by exchanges 521, 522, 523 on FIG. 5D.

These control addressing plan addresses (typically IP addresses) can be attributed in a distributed manner, for example in accordance with the normative document RFC 3927 “Dynamic Configuration of IPv4 Link-Local Addresses” or in accordance with the normative document RFC 4862 “IPv6 Stateless Address Autoconfiguration”. It should be noted that the OSI-model layer-3 addresses used by messages (or data packets) that must be propagated by the bridge devices B0 120, B1 121, B2 122 in the mesh communication network 100 constitute a domestic addressing plan, separate from the control addressing plan. It is the addresses of the domestic addressing plan, rather than those of the control addressing plan, that appear in the lists L0 410, L1 411, L2 412.

Each time a bridge device is added or removed, a dynamic-routing review takes place because of the change in topology of the mesh communication network 100. Communications between immediate neighbours among the bridge devices B0 120, B1 121, B2 122 take place once again, and the lists L0 410, L1 411, L2 412 are then updated accordingly. Likewise, each time a link between bridge devices is added or removed, communications between immediate neighbours among the bridge devices B0 120, B1 121, B2 122 also take place, in order there also to update a topological representation of the mesh communication network 100 with each bridge device B0 120, B1 121, B2 122, thus making it possible to determine in real time which are the routes most adapted for reaching each device in the mesh communication network 100 or connected to the communication network 100.

It should be noted that, for detecting the appearance or disappearance of a port (typically activation of a bridge-device interface), events are generated by the bridge device concerned, to give rise to the allocation or respectively the deletion of a control addressing plan address related to the port in question. This modification to the control addressing plan is propagated between the bridge devices B0 120, B1 121, B2 122 to reflect the topology of the mesh communication network 100.

Each time a station device is added or removed, the routes involving the station device in question (source or destination) are calculated by updating the dynamic routing accordingly. The addition, or removal, of a station device leads to the appearance, or respectively the disappearance, of a layer-3 address in the OSI model (typically an IP address). For example, the bridge devices B0 120, B1 121, B2 122 listen to and analyse various frames circulating in the mesh communication network 100, such as the DHCP and ARP (“Address Resolution Protocol) frames, to identify the equipment present and to determine the MAC and IP addresses thereof. For example, there are various technologies for detecting the IPv4/IPv6 addresses of devices connected to a communication network, such as the inspection of frame data-packet headers, or the deep inspection of DHCP (IPv4) or Neighbour Advertisement (IPv6) etc messages. Detecting the appearance/disappearance of a layer-3 address of the OSI model makes it possible to add/eliminate it in the dynamic routing. Each bridge device B0 120, B1 121, B2 122 detecting an appearance/disappearance of a layer-3 address of the OSI model propagates corresponding information to the other bridge devices B0 120, B1 121, B2 122 by exchanges of OSI-model layer-3 messages between immediate neighbours.

When a device is added, in a particular embodiment, the information also includes the OSI-model layer-2 address (typically the MAC address) of the device concerned. As explained above, the match between the OSI-model layer-2 address (typically a MAC address) and the OSI-model layer-3 address (typically an IP address) can be obtained by inspecting messages in the communication network 100 (typically messages transmitted in broadcast mode), such as for example DHCP or ARP frames.

Thus the first configuration of a first logic network is obtained by OSI-model layer-3 message exchanges between immediate neighbours among the bridge devices B0 120, B1 121, B2 122.

Then each bridge device B0 120, B1 121, B2 122 is informed of the presence of the station device STA1 141 by its OSI-model layer-3 address and of the optimised path in the communication network to reach it with a view to the first configuration of a first logic network.

Then, as illustrated schematically on FIG. 5E, the lists L0 410, L1 411, L2 412 are updated with an entry corresponding to the OSI-model layer-3 address (typically the IP address) of the station device STA1 141 associated with the identifier of the port (of the bridge device in question) to be used for conveying packets in unicast mode to said station device, as determined by the dynamic routing.

And, to allow optimised routing of the transmissions in unicast mode in the mesh communication network 100, each bridge device B0 120, B1 121, B2 122 performs a retranscription of this entry corresponding to the OSI-model layer-3 address from the list L0 410, L1 411, L2 412 in question to the corresponding forwarding database FDB0 420, FDB1 421, FDB2 422.

As illustrated schematically on FIG. 5F, is it is then clear from this that the forwarding databases FDB0 420, FDB1 421, FDB2 422 are reviewed as required, and considering that the path for reaching the station device STA1 141 from the bridge device B2 122 is shorter passing through the port 1 of the bridge device B2 122 rather than through the port 3 of the bridge device B2 122, the corresponding entry in the forwarding database FDB2 422 is updated accordingly.

Thus, when a data packet must be sent or propagated in unicast mode by the bridge device B2 122 to the station device STA1 141, the port 3 of the bridge device B2 122 is used. Conveying the data packet in unicast mode is thus optimised (first logic network) and does not follow the spanning tree (second logic network) that was able to be established in accordance with the current topology of the mesh communication network 100.

In a particular embodiment, when the device DEV0 110 is a residential gateway offering access to a wide area network, an interface for access to the wide area network can be exported (made visible) in the mesh communication network 100 by the device DEV0 110 as a separate device connected to the mesh communication network 100. This interface for access to the wide area network is connected to one of the ports of the bridge device B0 120 (for example the port 1 of the bridge device B0 120). A layer-2 address in the OSI model (typically a MAC address) is allocated to this interface for access to the wide area network, and the steps in FIGS. 3A and 3B are performed for the interface for access to the wide area network as for any station device connected to the mesh communication network 100. Thus the interface for access to the wide area network is taken into account in the dynamic routing in a simple and effective manner, and the station devices connected to the mesh communication network 100 easily have access to the wide area network, such as the internet, while benefiting from optimised routing in unicast mode in the mesh communication network 100.

In a particular embodiment, when the behaviours of bridge devices described above are implemented while taking a conventional bridge device as starting point, it should be noted that the learning and forwarding functions of this conventional bridge device must be eliminated or deactivated, so as not to come into conflict with the dynamic routing and the retranscription of its result in the forwarding database, as proposed above.

1. A method for transmitting data packets in a mesh communication network of the local area network type that interconnects bridge devices, wherein each bridge device uses in parallel:
a first configuration of a first logic network, which is used for conveying data packets in unicast mode, and which is defined by a dynamic routing between the bridge devices; and
a second configuration of a second logic network, which is used for conveying data packets in broadcast or multicast mode, and which is defined as a spanning tree by blocking one or more ports of the bridge devices to eliminate one or more loops in the mesh communication network,
wherein, in each bridge device, the first configuration of a first logic network involves a retranscription of a list at layer 3 of the OSI model in a forwarding database of layer 2 of the OSI model, the list listing the OSI-model layer-3 address of each device of the mesh communication network or connected to the mesh communication network in association with a port identifier of the bridge device in question to be used for conveying data packets intended for the device in question, the list being obtained during the dynamic routing.

2. The method according to claim 1, wherein the second configuration of a second logic network is obtained by using a virtual local network.

3. The method according to claim 1, wherein, when a new station device is connected to a port of a said bridge device, each bridge device performs the following steps:
using the second configuration of the second logic network for conveying, in the mesh communication network, a discovery request coming from the new station device;
updating the OSI-model layer-2 forwarding database of the bridge device in question with a MAC address of the new station device in association with an identifier of the port, of the device in question, by which the discovery request arrived;
using the OSI-model layer-2 forwarding database thus updated to convey, in the mesh communication network, a response to the discovery request, in which an OSI-model layer-3 address, which is allocated to the new base station, is included;
enriching the list at layer 3 of the OSI model with the OSI-model layer-3 address, which is allocated to the new base station, and determining the port identifier to be associated therewith by means of the dynamic routing;
modifying the OSI-model layer-2 switching database of the bridge device in question to retranscribe, where applicable, the dynamic routing corresponding to the OSI-model layer-3 address allocated to the new station device.

4. The method according to claim 1, wherein the first configuration of the first logic network is obtained by OSI-model layer-3 message exchanges between immediate neighbours of the mesh communication network among the bridge devices.

5. The method according to claim 1, wherein the first configuration of a first logic network and the second configuration of a second logic network are updated in the event of change of topology of the mesh communication network that interconnects the bridge devices, and wherein the first configuration of a first logic network only is updated in the event of connection of a station device to the mesh communication network or of disconnection of the station device from the mesh communication network.

6. A non-transitory information storage medium comprising instructions causing an implementation of the method according to claim 1, when the instructions are read from the information storage medium and executed by a processor.

7. A bridge device intended to be used in a mesh communication network of the local area network type that interconnects several such bridge devices, the bridge device comprising electronic circuitry configured to use in parallel:
a first configuration of a first logic network, which is used for conveying data packets in unicast mode, and which is defined by a dynamic routing between the bridge devices; and
a second configuration of a second logic network, which is used for conveying data packets in broadcast or multicast mode, and which is defined as a spanning tree by blocking one or more ports of the bridge devices to eliminate one or more loops in the mesh communication network,
wherein the bridge device is configured such that the first configuration of a first logic network involves a retranscription of a list at layer 3 of the OSI model in a forwarding database of layer 2 of the OSI model, the list listing the OSI-model layer-3 address of each device of the mesh communication network or connected to the mesh communication network in association with a port identifier of the bridge device in question to be used for conveying data packets intended for the device in question, the list being obtained during the dynamic routing.

8. A mesh communication network of the local area network type that interconnects several bridge devices according to claim 7.

9. The mesh communication network according to claim 8, wherein one said bridge device is included in a residential gateway and the other said bridge devices are respectively included in extenders of a local area network.
